(19) United States
(12) Patent Application Publication
(10) Pub. No.: US 2015/0324068 A1
(43) Pub. Date: Nov. 12, 2015

(54) USER INTERFACE STRUCTURE (UIS) FOR GEOGRAPHIC INFORMATION SYSTEM APPLICATIONS

(71) Applicant: Rolta India Ltd, Mumbai (IN)

(72) Inventors: Sheetal Bellare, Mumbai (IN); Gauri Lalwani, Mumbai (IN); Pragnesh N. Mistry, Mumbai (IN); Laxmidhar V. Gaopande, Mumbai (IN)

(73) Assignee: Rolta India Ltd, Mumbai (IN)

(21) Appl. No.: 14/272,530

(22) Filed: May 8, 2014

(51) Int. Cl. G06F 3/0482; G06F 3/0488; G06F 3/0484

(52) U.S. Cl. CPC G06F 3/0482; G06F 3/04842; G06F 3/04886

(57) ABSTRACT

Disclosed herein is a Geographic Information System (GIS) application comprising of a plurality of collapsible drawers, wherein the drawers comprise of the tools, options and information related to the map being currently displayed. The drawers may be collapsed/expanded by the user by clicking on a handle associated with each of the drawers. The collapsed drawers enable the user access to maximum screen space, enabling them to view more information on large maps.

### TECHNICAL FIELD

The embodiments herein relate to Geographic Information Systems (GIS) and, more particularly, to the User Interface Structure (UIS), which is a framework for serving various user interactions components in a methodical easy to use and intuitive manner in GIS applications.

### BACKGROUND

Currently, GIS based applications comprise of a scattered plurality of tools and options, which are used and/or viewed by the user on a continuous basis. The user may use these tools to perform operations from the inception of the creations of maps to very complex multilayered map data across platforms, devices and other technology environments where a map or map data is being displayed in the GIS application either for creation of maps of for consumption of map data by its users. The user may also use a plethora of options and tools to view information related to the maps and various options related to the maps being displayed by the GIS application. Ideally, the user should be able to view the maps and tools and options (as required) as per the requirements of the user.

However, considering the size of available displays, some of the screen sizes is limited and the user may not be able to view the maps and/or the tools optimally on the available display size, this is true even for larger monitors and even large screen digital display walls, map view is desired to be clutter free by most users. The user may have to opt between viewing the map in its majority on the visible display with the tools being minimized and the viewing the map in a smaller portion of the visible display with the tools occupying a larger portion of the visible display or the user in most cases has to abandon the map and perform tasks not knowing how they will result in showing those on the map itself.

### BRIEF DESCRIPTION OF THE FIGURES

The embodiments herein will be better understood from the following detailed description with reference to the drawings, in which:

FIG. 1a illustrates a computing device comprising of a GIS application, according to embodiments as disclosed herein;

FIG. 1b illustrates a system comprising of plurality of clients connected to a server through a network, wherein the network enables the client to access the GIS application present on the server, according to embodiments as disclosed herein;

FIG. 1c illustrates a plurality of clients connected to the cloud, wherein the network enables the client to access the GIS application present on the cloud, according to embodiments as disclosed herein;

FIG. 2 depicts the computing device comprising of the GIS application, according to embodiments as disclosed herein;

FIGS. 3a, 3b, 3c, 3d and 3e illustrate screenshots of the GIS application, according to embodiments as disclosed herein;

FIGS. 4a, 4b, 4c, 4d, 4e and 4f depict components of the west drawer, according to embodiments as disclosed herein;

FIGS. 5a, 5b, 5c, 5d and 5e depict components of the east drawer, according to embodiments as disclosed herein;

FIG. 6 illustrates a computing environment implementing the method for enabling a user to access a GIS application, according to embodiments as disclosed herein; and

FIGS. 7a, and 7b are example illustrations of different drawer access means and overlapping scenarios respectively, according to embodiments disclosed herein.

### DETAILED DESCRIPTION OF EMBODIMENTS

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art create, visualize and analyze GIS Map data to practice the embodiments herein. Accordingly, the examples should not be construed as limiting the scope of the embodiments herein.

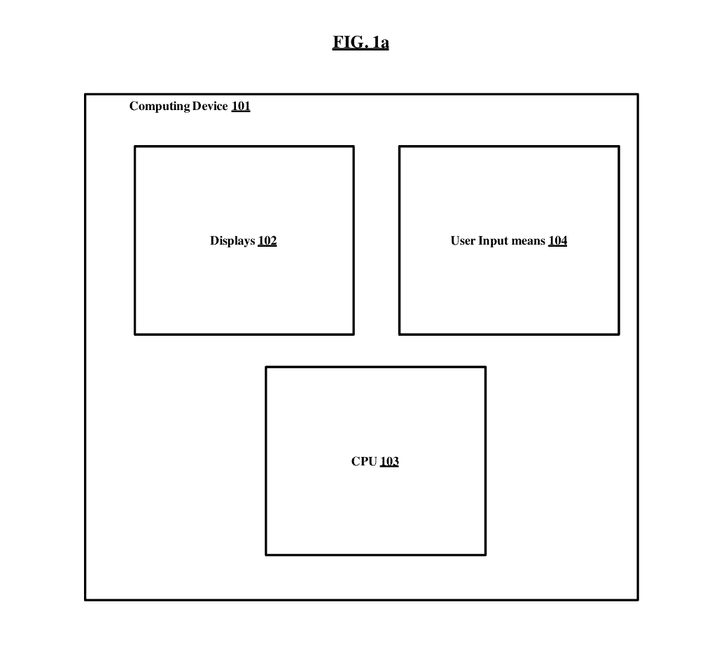

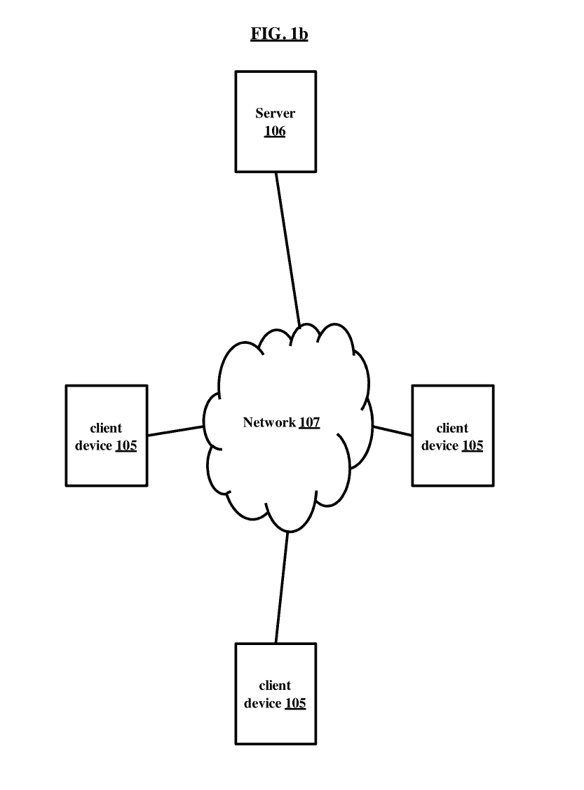

The embodiments herein disclose a method and system for enabling a user to create, access and use a GIS (Geographic Information Systems) application. Referring now to the drawings, and more particularly to FIGS. 1 through 7, where similar reference characters denote corresponding features consistently throughout the figures, there are shown embodiments.

FIG. 1a illustrates a computing device comprising of a GIS application, according to embodiments as disclosed herein. The GIS application, which is represented as a Global Application Framework, represents common elements across all views in the main application window. The framework utilizes one screen real estate to maximize workspace by providing multiple collapsible drawers, and allows for a flexible framework. Drawers are arranged such that they may be moved around, and pulled out as independent floating drawers. Further, options are provided to enable a user to customize the tools based on task requirements.

Default application screen displays work area, and four drawers for navigation/interaction. Each drawer will contain different information. The drawers expand or collapse by clicking on drawer handles. Further, options are provided to customize default page view. For example, for most of the roles of user/user group, default state of the screen may be with all drawers collapsed which makes working area visible to user with drawer branding. In a preferred embodiment, options may be provided to customize default view for selected roles of user with specific draw open by default. Another option may be provided to conveniently re-size the draw display window.

Each draw is intended to provide certain navigational, and interaction elements to the user; which the user may access by clicking on the respective handles. A drawer that is open may be closed by clicking on the handle again, and sign on the handle is then inverted. Some of the drawers may be closed by clicking anywhere on the screen. Area of the screen covered by each drawer may vary depending on the information each drawer is configured to convey. For example, a drawer that provides map view may occupy the whole screen to provide full screen map view to the users, whereas the drawers that carry tools and other feature options may occupy only a portion of the screen, still keeping a certain percentage of the image or file visible. The collapsible view option provides the users maximum screen space to work on, and helps them deal with large maps/images in a convenient way. An overview window may be provided at a convenient location in the main display window, and the overview may act as a navigational tool which helps the user to jump directly to a portion of the map in the work area, by clicking on an area in the overview window. Zoom option may be provided with the overview window as an optional setting.

When multiple files are open in the work area, by default they may appear as tabs a specific location in the window. Each file may be accessed by clicking on its respective tabs, and placement of tabs shifts with opening and closing of the drawers. A global application toolbar is available to users for quick updating, viewing in the desired manner, and which provides other useful utilities for the user. In an embodiment, the global application toolbar may provide same options/settings for all users irrespective of their roles. In another embodiment, options may be provided to customize global toolbar options according to certain parameters such as but not limited to user role. For example, some of the options that may be provided in the global toolbar are, but not limited to pointer, pan, zoom, contrast and brightness, rotate, measure, find, and different viewing options of files.

The computing device 101, as depicted, comprises of a displays 102 as there could be multiple displays, a user input means 104 and a CPU (Central Processing Unit) 103. The computing device 101 may be at least one of a desktop computer, a laptop, a tablet, a smart phone, a mobile phone or any other device capable of accessing the GIS application. The display 102 may enable a user of the computing device 101 to interact with, view or share the information. The display 102 may be a monitor or an array of monitors amounting to more than 1 which is a separate display device(s) connected to the other components of the computing device 101 using a cable/wire, an integrated display present in the body of the computing device 101 and so on. In an embodiment herein, the display 102 may comprise of more than one display devices. The user input means 104 may enable the user of the computing device 101 to interact with the computing device 101. The user input means 104 may comprise of at least one of a physical keyboard, a normal mouse, a 3D GIS mouse, a touchpad, a joystick, an on-screen keyboard, a touchscreen and so on. The user may use more than one user input means 104 at a time to interact with the computing device 101. The CPU 103 comprises of a computing means enabling the computing device 101 to perform computing functions along with a graphic processor to process raw imagery files for use in the creation of GIS data. The CPU 103 may be a separate device connected to the display 102 and the user input means 104 using a suitable means such as cable/wires and so on. The CPU 103 may be integrated with at least one of the display 102 and the user input means 104. The CPU 103 enables the user to access and operate the GIS application. The GIS application may be a browser based application (web application), which may be accessed by the user using a browser present on the computing device 101. The GIS application may be a stand-alone GUI (Graphical User Interface) based application, which the user may access directly using the computing device 101.

FIG. 1b illustrates a system comprising of plurality of one of the possibilities where clients are connected to a server through a network, wherein the network enables the client to access the GIS application present on the server, according to embodiments as disclosed herein. The system comprises of a plurality of client devices 105 connected to at least one server 106 through a network 107. The client device 105 may be at least one of a desktop computer, a laptop, a tablet, a smart phone, a mobile phone, public and private kiosks or any other device capable of accessing the GIS application using the network 107. The network 107 may be at least one of the internet, a LAN (Local Area Network), a WAN (Wide Area Network) and so on, which may enable a plurality of client devices 105 to access the GIS application resident on the server 106. The GIS application may be a browser based application (web application), which may be accessed by the user from the server 106 using a browser present on the client device 105. The GIS application may be a stand-alone GUI (Graphical User Interface) based application, which the user may access directly using the client device 105. The UIS framework disclosed herein has various applications such as but not limited to creation of GIS data, GIS data visualization, and GIS image processing using a totally isolated and standalone system, which may or may not be hosted on the network.

FIG. 1c illustrates a plurality of clients connected to the cloud, wherein the internet enables the client to access the GIS application present on the cloud, according to embodiments as disclosed herein. FIG. 1c depicts a plurality of client devices 105 connected to the cloud through the internet 108. The client device 105 may be at least one of a desktop computer, a laptop, a tablet, a smart phone, a mobile phone or any other device capable of accessing the GIS application using the network 107. The client device 105 may access the GIS application through the cloud. The GIS application may be a browser based application (web application), which may be accessed by the user from cloud using a browser present on the client device 105. The GIS application may be a stand-alone GUI (Graphical User Interface) based application, which the user may access directly using the client device 105. It is to be noted that cloud deployment is one way of implementing the UIS framework disclosed herein. The architecture shown in FIG. 1c, and corresponding description provided herein is not intended to limit mode of implementation of the UIS framework to the cloud based architecture only.

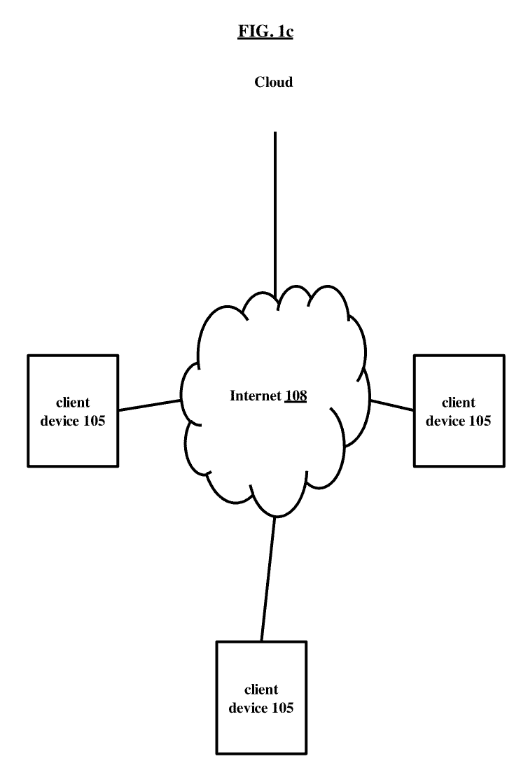

FIG. 2 depicts the computing device comprising of the GIS application, according to embodiments as disclosed herein. The figure depicts a CPU 103 containing a display interface 201, a user input interface 202, a processor 203, a memory 204 and a network interface 205 and a bus 206. The display interface 201 enables the CPU 103 to communicate with the display 102. The display interface 201 may comprise of the drivers required for the CPU 103 to communicate with the display 102 and at least one physical port and/or connector which connects the CPU 103 to the display 102. In an embodiment herein, the display interface 201 may enable the CPU to communicate with a plurality of displays 102. The user input interface 202 enables the CPU 103 to communicate with the user input means 103. The user input interface 202 may comprise of the drivers required for the CPU 103 to communicate with the user input means 104 and at least one physical port and/or connector which connects the CPU 103 to the user input means 104. The processor 203 is configured to enable a plurality of applications resident on the CPU to be executed. Examples of the applications may be a browser, a standalone GUI based application and so on. The memory 204 may comprise of a volatile memory and a non-volatile memory. The memory 204 may be configured applications, data related to the applications and so on. The memory 204 may configured to make the applications and/or data available, on receiving a request from the processor 203. The network interface 204 may enable the CPU 103 to interface with at least one network. The network may be at least one of the internet, a LAN (Local Area Network), a WAN (Wide Area Network) and so on. The network interface 205 may comprise of the drivers required for the CPU 103 to communicate with the network and at least one physical port and/or connector which connects the CPU 103 to the network. The bus 206 connects the above mentioned components and enables the above mentioned components to communicate with each other.

On the user invoking the GIS application (either directly or entering a URL (Uniform Resource Locator) in a browser) using the user input means 104, the processor 203 receives instructions through the user input interface 202. The processor invokes the GIS application. The processor 204 may make the GIS application visible to the user on the display 102 using the display interface 201. The processor 204 may make an expanded view of map area of the GIS application visible to the user. The display may comprise of a reduced tool bar, which may be displayed in the upper region of the display. The GIS application may comprise of a plurality of drawers, referred to herein as a north drawer, a west drawer, a south drawer and an east drawer. The drawers may be in a collapsed form, when displayed to the user initially or animate and show it presence and use contextually. Each of the drawers may have a handle, which may be used by the user to expand the respective drawer. The drawers also have the ability to contextually open up in co relations to a specific action performed by the user to intuitively guide the user to perform a task. The handles may be used to collapse the respective drawers, it is pertinent to mention that the drawers in the framework are also designed to collapse contextually when the main map area is accessed of clicked on for a particular action, unless the drawer are locked from collapsing.

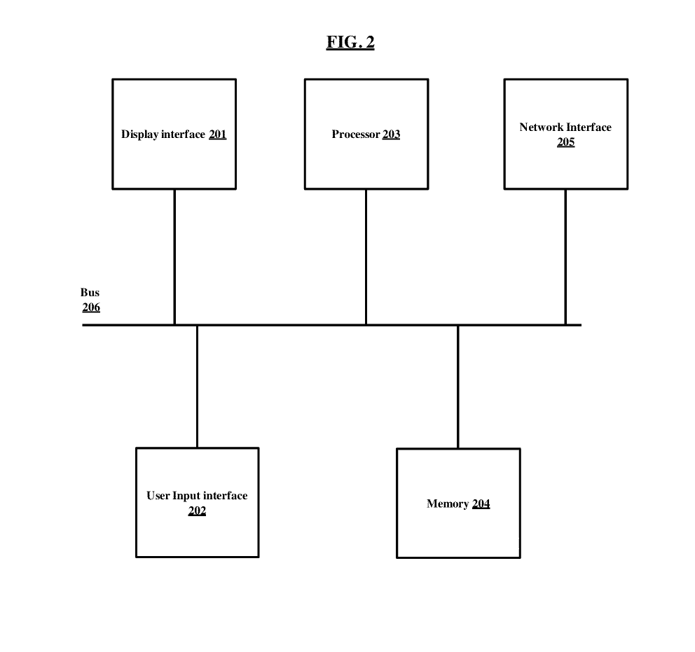

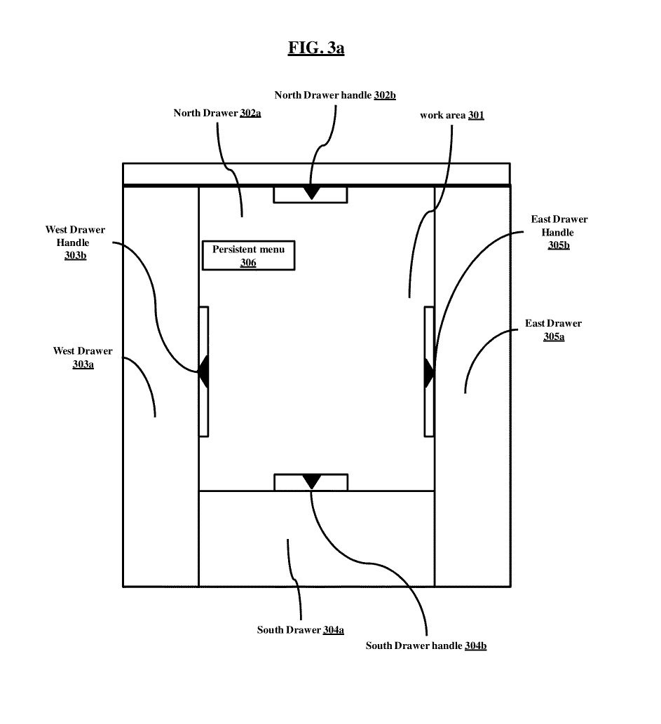

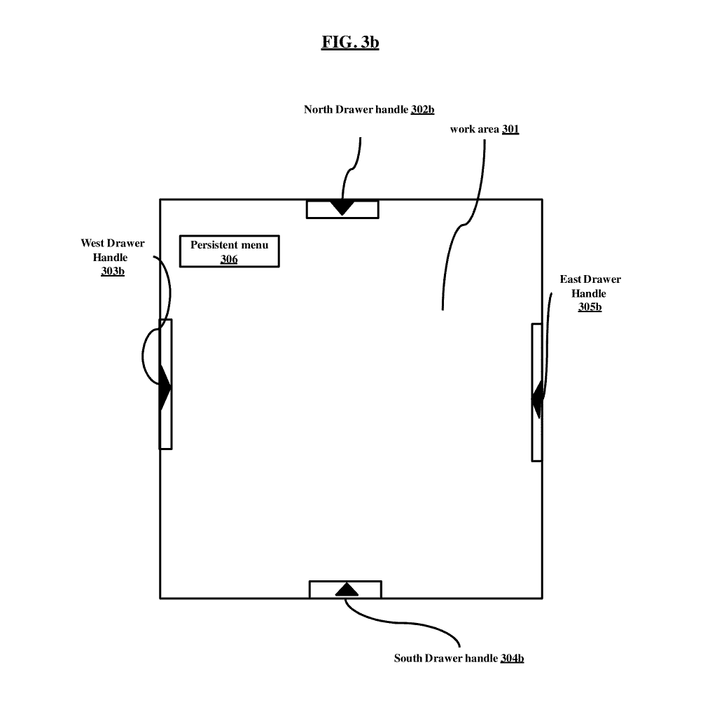

FIGS. 3a, 3b, 3c, 3d and 3e illustrate screenshots of the GIS application, according to embodiments as disclosed herein. FIG. 3a depicts the GIS application, with the north, west, south and east drawers 302a, 303a, 304a and 305a in the expanded mode. Each of the drawers may have a handle associated with it, 302b, 302c, 302d and 302e. The user may collapse the drawers by clicking on the respective handles. FIG. 3b depicts the GIS application with all the drawers collapsed. The respective handles remain visible, with the user being able to expand the drawers by clicking on the respective handle. FIG. 3c depicts the GIS application with only the south drawer 304a in expanded form, while the other drawers are collapsed. FIG. 3d depicts the GIS application with two drawers, the north drawer 302a and the east drawer 305a in expanded form, while the west drawer 303a and the south drawer 304a are collapsed. FIG. 3c depicts the GIS application with only the south drawer 304a in collapsed form, while the other drawers are expanded. FIG. 3e depicts GIS application when the north drawer is expanded. The north drawer, when expanded, covers entire area, overlapping other drawers.

The handle 302b, 303b, 304b and 305b may comprise of a tab-like extension to the drawer, wherein each drawer may have a handle associated with it. The handle 302b, 303b, 304b and 305b may be always visible and may enable the user to collapse and/or expand the drawers. The handle may comprise of a triangular arrow, with the arrow changing depending on whether the respective drawer is in expanded or collapsed form.

The north drawer 302.a is located on the top portion of the display window is for global menu bar, and file management. On mouse over, the top drawer expands and the global menu bar is visible and may be accessed. On the other hand, it may be configured to be visible and accessible at all times. Tools/options in the north drawer 302.a may be accessed by performing a pre-configured action. The pre-configured action mentioned here could be any action such as but not limited to rolling mouse over, or clicking on an icon provided.

A menu bar pops up upon executing a pre-configured menu access means. While menu bar of the north drawer 302.a is visible to the user, all other drawers are visible and accessible for the user. The menu bar provides generic/user role specific menu options for the user to access various functions/settings according to their work environment requirements. A “tools menu” provides access to various tools that the user's work environment demands.

The north drawer 302.a, when expanded, opens above the work area 301 and displays project management/file management information along with various associated options. Since the user has logged in to the system, user specific information, based on their assigned rights and role on the project, may be displayed within the tabs. Users are provided limited/restricted access to the project management, and file management information and associated management actions.

File/project management tabs associated with the north drawer menu provides 3 different types of views for easy access to files. They are:

1) Map view: The map view uses a generic map to display the files, indicating their geographic location (based on geo-referencing parameters). The map view may be used for file management as well as project management purposes.

When used for the file management process, files are represented as icons over a generic map, as per their geo-referencing parameters. A zoom option helps user to zoom into an area in the map from where a file need to be selected. A timeline feature helps to sort files based on time frame that they belong to, and options to set up duration of the timeline may be provided at group management level and/or individual user level. The system further provides at least one filter to aid the user with file selection process. For example, file selection may be based on file type using a filter that permits to do so. Drawer handle indicates using different symbols (in this example, inverted symbols) whether the drawer is collapsed or not. The user is provided option to select/deselect files and also to open the files in “reference mode” or “edit mode”. When a file is opened in “reference mode”, edit/modify options are disabled by the system and the user may only view contents of the file. If the file needs to be edited/modified, it may be opened in the “edit mode” in which the system provides editing options to the user. Further, on rolling over an icon on the map, a preview of the file in question appears next to it. This is enabled as a preview feature.

When the map view is used for project management purpose, it helps a user to perform activities like checking status, allocation and accessing reports with the help of a map interface. In this application, a generic map is used to display project locations and a grid structure defined by a project set up team. The grid dimensions may be changed by an authorized person such as a project manager, to change work area 301. The work area 301 feature allows project managers to get details of each of the allocated areas, their teams and their work status as any of “Completed”, “Work in progress”, or “Not started”.

Upon clicking on “work area” option, a secondary window is opened that helps project managers to do various project management activities. A “Detailed status” tab may provide the manager options for getting detailed status of progress of activities for selected team/member, and to leave a message for a particular team regarding progress of the project. An allocation tab helps to allocate and re-allocate activities within a work area 301 to different teams/members. A message tab helps user to read messages sent by a particular team, and to send message to selected team.

A zoom option helps user to zoom into an area in the map from where a file need to be selected. A timeline feature helps to sort files based on time frame that they belong to, and options to set up duration of the timeline may be provided at group management level and/or individual user level. Drawer handle indicates using different symbols (in this example, inverted symbols) whether the drawer is collapsed or not. Different options are provided for users to switch between different views of the map.

2) Activity View: The activity view allows users to view/access files categorized as per the activities that have been performed. An activity column in the activity view displays files listed as per single activity, wherein the activity may be set up by project set up team based on nature of acquired project. The system indicates to the user icons used to represent different kinds of files. Drawer handle indicates using different symbols (in this example, inverted symbols) whether the drawer is collapsed or not. Over view and preview options are provided to indicate location of file in a map area, and to preview a file before selection respectively. The user is provided option to select/deselect files and also to open the files as files that need to be worked on, or as reference files.

The west drawer 303a depicts layers, which may comprise of information such as but not limited to images, vector files, and enhancements. The drawer expands on mouse click, and then the layers are visible for the user, and at this time, the bottom drawer may not be visible. The West drawer 303a has varying interaction and content as per the role of a user. In the west drawer, layers are stored in folders based on type of information they possess, and the folders may be opened and collapsed to view layers within. The system highlights a selected layer, and also provides option to make layers visible/invisible. Control options are provided for user to perform actions such as moving a layer up/down, opening a file within a layer, deleting a layer, and locking a layer. An option is provided for the user to dock a drawer, upon which work area 301 re-sizes to accommodate the drawer. Drawer handle indicates using different symbols (in this example, inverted symbols) whether the drawer is collapsed or not.

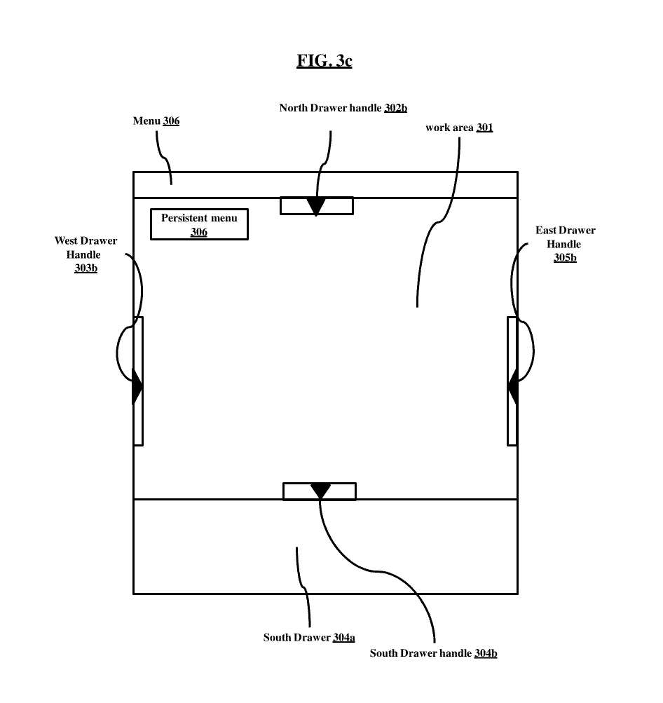

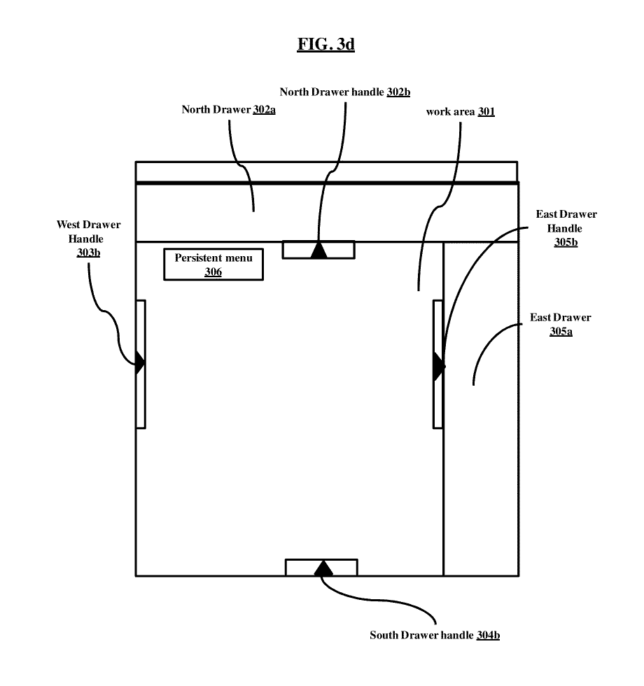

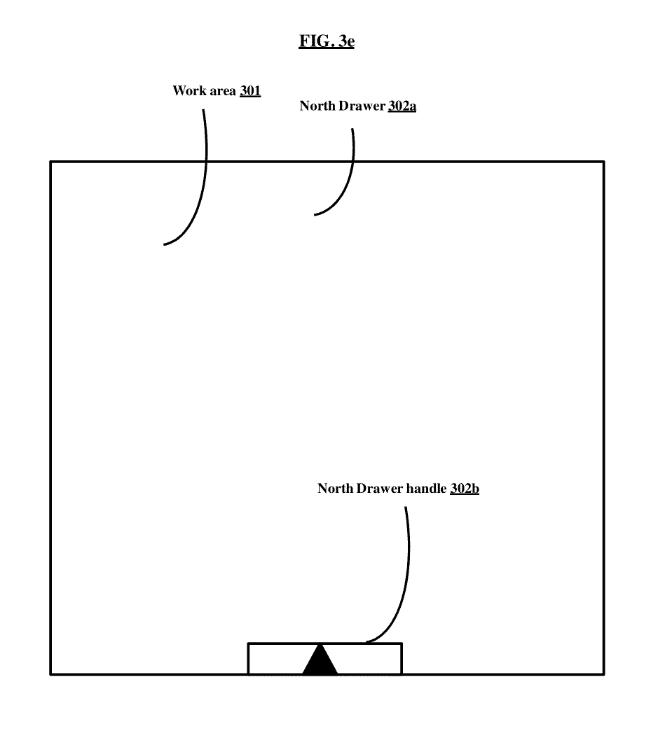

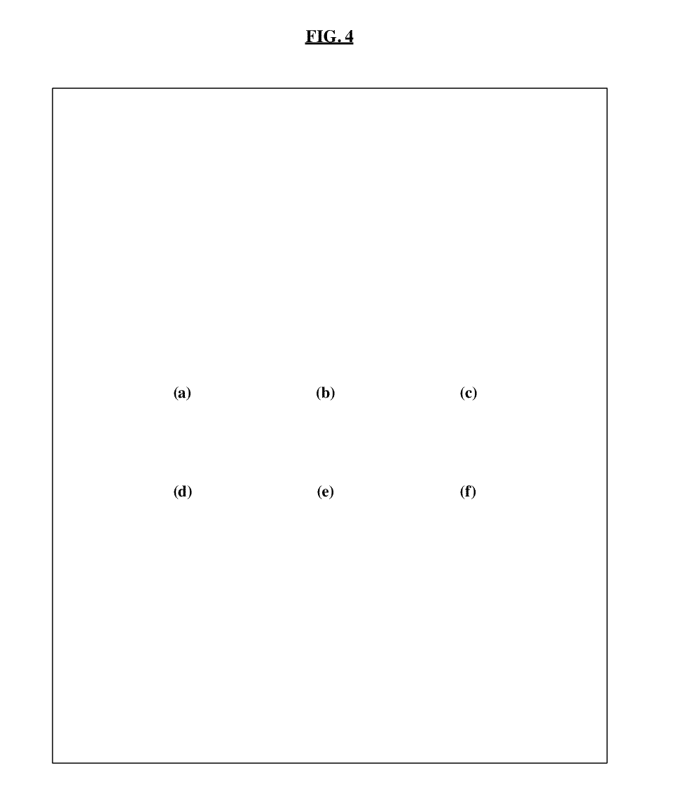

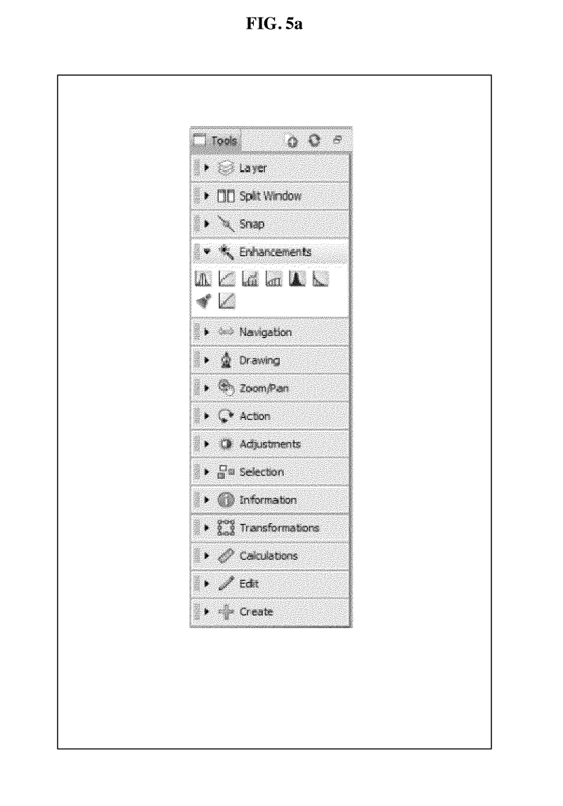

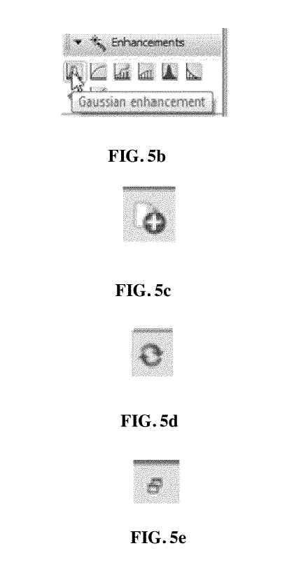

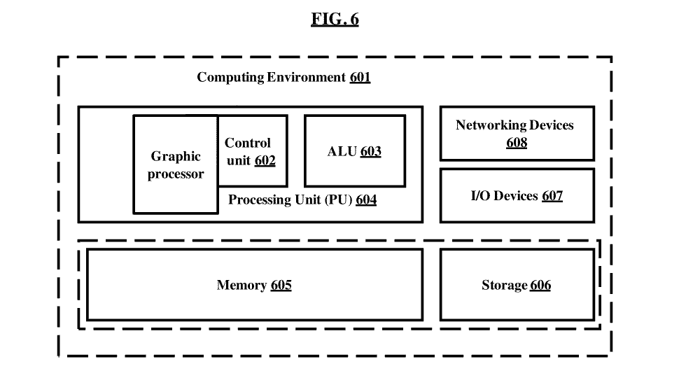

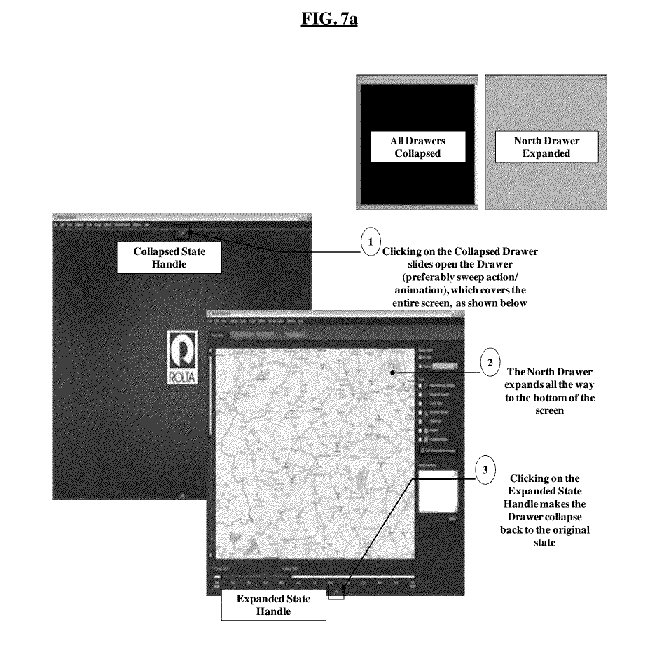

The east drawer 305a is for accessing the task based toolbars (as in FIG. 4) and may be expanded by clicking on the drawer 305b. The tools may be organized and grouped according to its task (as depicted in FIG. 5a). The tools may further display its related group of tools. Each of the icons may have associated tooltips, which may be displayed by hovering on the tool (as depicted in FIG. 5b). The user may move tools into the work area 301 by performing a drag and drop operation. The user may add tools to his favourites, using the ‘add to favourites’ option (as depicted in FIG. 5c). The user may use a ‘reset feature’ (as depicted in FIG. 5d) to reset all the tolls to its default state. The user may use a pin-unpin feature to dock/undock the east drawer 305a (as depicted in FIG. 5e). The user may collapse the east drawer 305a by clicking on the handle 305b.

It appears below the top drawer and expands till bottom of the screen. When the east drawer 305a is expanded, the top drawer is visible and accessible, whereas the bottom drawer is not.

The tools provided by this drawer are based on primary tasks of the users, which are determined by the system based on login information of the user. In the display window, tools are stacked vertically with icon and name that depicts each tool; and user may choose task based tool sets from “Tools menu”, and dock them on the drawer. The user also gets option to customize a tool, and save it for further use. When a tool is selected by clicking on it, it will either open up in the work area 301, or within the tool drawer itself, which may be highlighted using a different background colour and/or font format. A tool may further comprise sub-tools which may be contained within the parent tool itself. Whenever a user selects a sub-tool, interaction option options within the tool changes accordingly. Tools have the ability to resize based on the interaction and content required, and a detachable zoom lens may be available with a tool dialog box by default, depending upon the nature and requirement of the tool. Options may be provided for the user to dock the drawer when needed. A few examples of different types of tools that may be provided with the east drawer 305a are mentioned below.

1) Expanded tool: This feature provides option to open an expanded tool below a selected tool in certain situations. For example, in cases when no secondary window may be placed over the work area 301 for technical or functionality related constraints, the expanded tool feature is useful. The expanded tool window may be closed when the user clicks on button for selected tool again.
2) Multi-preview dialogue box: Upon selecting certain tools on the right drawer, a dialog box appears on the work area 301. The multi-preview dialog box showcases multiple previews for an image with different settings, side by side for better comparison. The default size and ratio of the previews may be changed through the ‘Settings’ menu. Clicking on ‘OK’ applies the settings for the selected preview on the working image. Clicking on ‘Cancel’ disregards any changes/selection for a preview and closes the dialog box.
3) Non-persistent dialogue box: On selecting certain tools on the right drawer, a dialog box appears on the work area 301, for one time use or editing. It in turn affects the condition of the opened/selected file. Some of the instances of persistent dialog boxes may have within them simple or advanced forms, sub-tools, previews, analysis with output, input and output, wizards and so on.
4) Persistent dialogue box: A persistent dialog box remains open in the work area 301 on selection, for frequent use. The placement of the dialog box is in the centre by default but may be moved around and placed wherever the user finds convenient. In many cases, a zoom lens is attached to a persistent dialog box, clicking on which makes that it move with the cursor. Detaching a zoom lens from the dialog box leaves a cut wedge on the dialog box, indicating that it may be docked or attached again. On placing the zoom lens over that wedge and clicking attaches it to the dialog box. At times, the persistent dialog box may be a wizard, wherein the steps of the wizard have different tabs. The wizard may or may not be sequential. The persistent dialog boxes may possess simple or advanced forms, sub-tools, previews, analysis with output, input and output and so on. The action buttons for a step of the wizard lie within the tabbed area, whereas action buttons for the entire functionality lie outside the tabbed area.
5) Template tool: The template tool allows users to build upon a template. When a user clicks on an interface to access the template tool, a new file is opened that is represented as a separate tab and the template is displayed in that file. The template possesses a plurality of elements which helps the user to create content; and when the user clicks on an element on the template, pop up options are displayed for users to select content for that element.
6) Direct action Tool: Direct action tools are those which perform direct actions on opened/selected files. Such tools may not display a dialogue when selected by a user.

The South drawer 304a may be used for accessing any additional information about the opened and active file. It may possess coordinate, camera, projection, or any other information depending upon the file type and the available information. However, this information is subject to change depending on type of project, and role of the user. The south drawer 304a may be further divided into two parts namely a Primary Info Bar, and a Secondary Info Drawer. The primary info bar is the top part which is always visible and remains stuck to the bottom part. This usually contains the ‘Command Line’, and any other most important information on the open file. The secondary Info drawer is an expanding drawer, and contains secondary information that may be required for reference. On mouse click, the drawer expands upwards and the information is visible. The Primary Info bar gets shifted up along with the expanding secondary info drawer. When this drawer is open, all other drawers are visible. Further, this drawer may be collapsed by clicking on the handle, or anywhere else on the screen.

The south drawer 304a, when collapsed, displays the following options:

1) Primary info bar: The primary info bar remains constantly visible on the screen and provides primary information regarding the open file, the Command Field as well as the Map coordinates. It is glued to the Secondary Info drawer, and only slides up as the drawer expands.
2) Command field: The command field allows user to type in a command to access a tool or function. Pressing enter key after typing in desired tool's name opens the tool in the work area 301.
3) Map coordinates: This function shows map coordinates based on mouse movement.
4) Secondary Info Drawer: The secondary info drawer contains secondary information, which may be seen by expanding the drawer using a mouse click option.
5) Drawer Handle: The drawer handle is used to expand or collapse the drawer, and indicates current state (i.e. expanded/collapsed) using different inverted icons.

The user may customize the drawers by moving tools, options and information within the drawers, across drawers and so on. The persistent menu bar 306 appears in the work area always to provide quick access to selected features. The north drawer, when expanded, covers entire screen; whereas the other drawers are designed such that they occupy one third of the screen when expanded.

FIG. 6 illustrates a computing environment implementing the method for enabling a user to access a GIS application, according to embodiments as disclosed herein. As depicted the computing environment 601 comprises at least one processing unit 604 that is equipped with a control unit 602 and an Arithmetic Logic Unit (ALU) 603, a memory 605, a storage unit 606, plurality of networking devices 608 and a plurality Input output (I/O) devices 607. The processing unit 604 is responsible for processing the instructions of the algorithm. The processing unit 604 receives commands from the control unit in order to perform its processing. Further, any logical and arithmetic operations involved in the execution of the instructions are computed with the help of the ALU 603.

The overall computing environment 601 may be composed of multiple homogeneous and/or heterogeneous cores, multiple CPUs of different kinds, special media and other accelerators. The processing unit 604 is responsible for processing the instructions of the algorithm. Further, the plurality of processing units 604 may be located on a single chip or over multiple chips.

The algorithm comprising of instructions and codes required for the implementation are stored in either the memory unit 605 or the storage 606 or both. At the time of execution, the instructions may be fetched from the corresponding memory 605 and/or storage 606, and executed by the processing unit 604.

In case of any hardware implementations various networking devices 608 or external I/O devices 607 may be connected to the computing environment to support the implementation through the networking unit and the I/O device unit.

Embodiments disclosed herein enable utilization of screen real estate to maximize workspace for use in a GIS application by providing a plurality of collapsible drawers, wherein the collapsed drawers with all the tools, menus and functionality when hidden give users maximum screen real estate to work on and help them deal with large maps/images with ease.

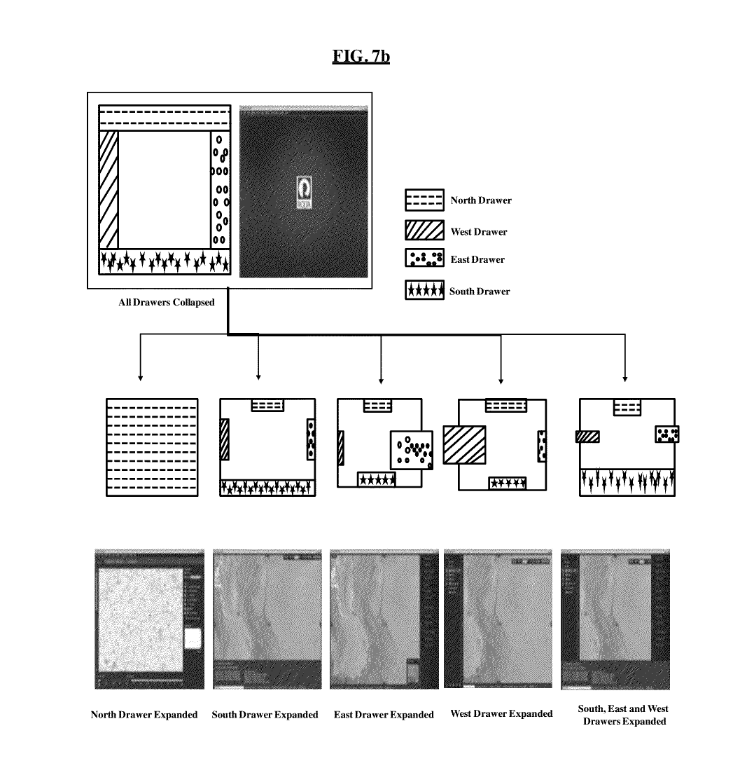

FIGS. 7a, and 7b are example illustrations of different drawer access means and overlapping scenarios respectively, according to embodiments disclosed herein. Each drawer can be expanded by clicking on corresponding drawer as depicted in FIG. 7a. Clicking the same handle collapses the expanded drawer back to original state. When expanded, the north drawer covers entire screen whereas the south, west, and east drawers cover only one third of the entire screen area. That means, when the north drawer is expanded, others drawers may not be visible. These scenarios are depicted in FIG. 7b.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the claims as described herein.

What is claimed is:

1. A method for optimizing work area in a GIS (Geographic Information Systems) application comprising
displaying the GIS application to a user on a display device, wherein the GIS application comprises of a plurality of drawers, each of the drawers further having at least one of a plurality of tools, a plurality of options and information related to a map being currently accessed by the GIS application;
expanding a drawer on the display device when the drawer is collapsed, by clicking a handle associated with the drawer using a user input means; and
collapsing a drawer on the display device when the drawer is expanded, by clicking the handle associated with the drawer using the user input means.

2. The method as claimed in claim 1, wherein the GIS application is used for at least one of creating GIS map data; and visualizing GIS map data.

3. The method as claimed in claim 1, wherein the GIS application comprises of four drawers.

4. The method as claimed in claim 1, wherein an expanded drawer displays at least one of a plurality of tools, a plurality of options and information present in the drawer to the user.

5. The method as claimed in claim 1, wherein the user customizes the at least one of a plurality of tools, a plurality of options and information present in the drawers.

6. A computer program product comprising computer executable program code recorded on a computer readable non-transitory storage medium, said computer executable program code when executed, causing a method for optimizing work area in a GIS (Geographic Information Systems) application, comprising:
expanding a drawer on the display device when the drawer is collapsed, by clicking a handle associated with the drawer using a user input means; and
collapsing a drawer on the display device when the drawer is expanded, by clicking the handle associated with the drawer using the user input means.

7. The computer program product as claimed in claim 6, wherein the GIS application is used for at least one of creating GIS map data; and visualizing GIS map data.

8. The computer program product as claimed in claim 6, wherein the GIS application comprises of four drawers.

9. The computer program product as claimed in claim 6, wherein an expanded drawer displays at least one of a plurality of tools, a plurality of options and information present in the drawer to the user.

10. The computer program product as claimed in claim 6, wherein the user customizes the at least one of a plurality of tools, a plurality of options and information present in the drawers.
